(19) United States
(12) Patent Application Publication
(10) Pub. No.: US 2006/0119521 A1
(43) Pub. Date: Jun. 8, 2006

(54) Wireless transmission apparatus and antenna rotation mechanism for use therein

(76) Inventor: Cheng-Chung Chang, Sijhih City (TW)

Correspondence Address: BIRCH STEWART KOLASCH & BIRCH, PO BOX 747, FALLS CHURCH, VA, 22040-0747, US

(21) Appl. No.: 11/001,050

(22) Filed: Dec. 2, 2004

(51) Int. Cl. H01Q 1/24

(52) U.S. Cl. 343/702

(57) ABSTRACT

A wireless transmission apparatus. A curved guide track is disposed on a base plate. An antenna holder is rotatably disposed on the base plate and includes a sliding portion. The sliding portion slides on the curved guide track when the antenna holder rotates. A main circuit board is disposed on the base plate. An enhanced antenna is disposed in the antenna holder and electrically connected to the main circuit board. The enhanced antenna rotates with the antenna holder.

### BACKGROUND

The invention relates to a wireless transmission apparatus, and in particular to a wireless transmission apparatus with a rotatable enhanced antenna.

An RF antenna is normally disposed in a conventional wireless transmission apparatus, such as a router, to enable two-way wireless signal transmission with a portable computer, a television, or other electronic devices. The RF antenna in the conventional wireless transmission apparatus, however, can only receive and transmit wireless signals within a predetermined distance. Namely, when the distance between an electronic device and the router exceeds the predetermined distance, two-way wireless signal transmission is unable to be performed, thereby limiting the operational area of the electronic device. To overcome the aforementioned problem, an enhanced RF antenna can be disposed on the exterior of the router to extend the distance of wireless signal transmission between the electronic device and the router. Nevertheless, when the router is not used or the wireless signal transmission between the electronic device and the router can be performed only by way of the RF antenna disposed therein, the enhanced RF antenna disposed on the exterior of the router adversely affects the appearance thereof.

Hence, there is a need for a wireless transmission apparatus with a rotatable enhanced antenna. When not used, the enhanced antenna can rotate to be received in the wireless transmission apparatus.

### SUMMARY

An exemplary embodiment of a wireless transmission apparatus comprises a base plate, a curved guide track, an antenna holder, a main circuit board, and an enhanced antenna. The curved guide track is disposed on the base plate. The antenna holder is rotatably disposed on the base plate and comprises a sliding portion. The sliding portion slides on the curved guide track when the antenna holder rotates. The main circuit board is disposed on the base plate. The enhanced antenna is disposed in the antenna holder and electrically connected to the main circuit board. The enhanced antenna rotates with the antenna holder.

The wireless transmission apparatus further comprises a pivot disposed on the base plate. The antenna holder pivots on the pivot and rotates between a first position and a second position.

The antenna holder further comprises a pivot hole in which the pivot is disposed.

The distance between the pivot hole and the sliding portion substantially equals that from the pivot to the curved guide track.

The curved guide track further comprises a first engaging portion and a second engaging portion, respectively disposed on opposite ends thereof. The sliding portion of the antenna holder engages the first engaging portion when the antenna holder rotates to the first position. The sliding portion of the antenna holder engages the second engaging portion when the antenna holder rotates to the second position.

The sliding portion comprises a protrusion and the first and second engaging portions comprise recesses.

The wireless transmission apparatus further comprises at least one internal antenna and a switching device, both electrically connected to the main circuit board. The wireless transmission apparatus selectively operates the enhanced antenna or internal antenna by means of the switching device.

The antenna holder further comprises an abutting portion between the pivot hole and the sliding portion. The abutting portion abuts the switching device to allow the wireless transmission apparatus to selectively operate the internal antenna when the antenna holder rotates to the first position. The abutting portion is separated from the switching device to allow the wireless transmission apparatus to selectively operate the enhanced antenna when the antenna holder rotates to the second position.

The wireless transmission apparatus further comprises a casing in which the base plate is disposed. The enhanced antenna is received in the casing when the antenna holder rotates to the first position. The enhanced antenna protrudes from the casing when the antenna holder rotates to the second position.

The casing further comprises an opening adjacent to the pivot and curved guide track. The antenna holder further comprises a barricade connected to the pivot hole thereof. The barricade covers the opening when the antenna holder rotates to the first position. The enhanced antenna protrudes from the opening when the antenna holder rotates to the second position.

The wireless transmission apparatus comprises a router.

The enhanced antenna comprises an SMA antenna.

The internal antenna comprises an RF antenna.

The switching device comprises a limit switch.

### DESCRIPTION OF THE DRAWINGS

The invention can be more fully understood by reading the subsequent detailed description and examples with references made to the accompanying drawings, wherein:

FIG. 1 is a schematic perspective view of a wireless transmission apparatus of an embodiment of the invention;

FIG. 2A is a partial perspective view showing operation of a wireless transmission apparatus of an embodiment of the invention;

FIG. 2B is a schematic plane view of FIG. 2A;

FIG. 3A is a schematic plane view of an antenna holder of a wireless transmission apparatus of an embodiment of the invention;

FIG. 3B is a schematic side view of FIG. 3A;

FIG. 4A is another partial perspective view showing operation of a wireless transmission apparatus of an embodiment of the invention;

FIG. 4B is a schematic plane view of FIG. 4A;

FIG. 5A is another partial perspective view showing operation of a wireless transmission apparatus of an embodiment of the invention;

FIG. 5B is a schematic plane view of FIG. 5A; and

FIG. 6 is another schematic perspective view of a wireless transmission apparatus of an embodiment of the invention.

### DETAILED DESCRIPTION

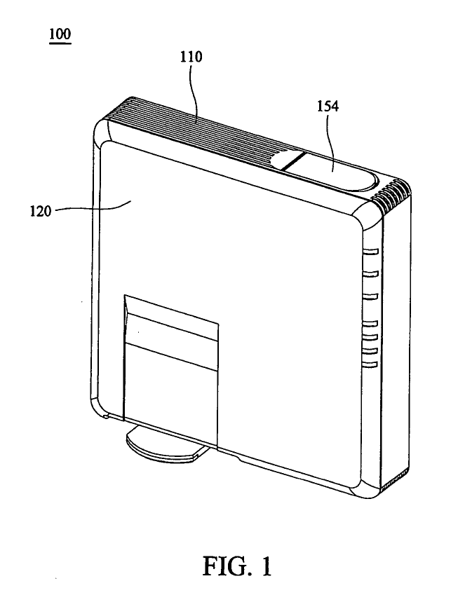

Referring to FIG. 1, a wireless transmission apparatus 100 of an embodiment can be a router comprising is a top cover (not shown), a casing 110, and a bottom cover 120. The top cover and bottom cover 120 are omitted for simplicity of the later description.

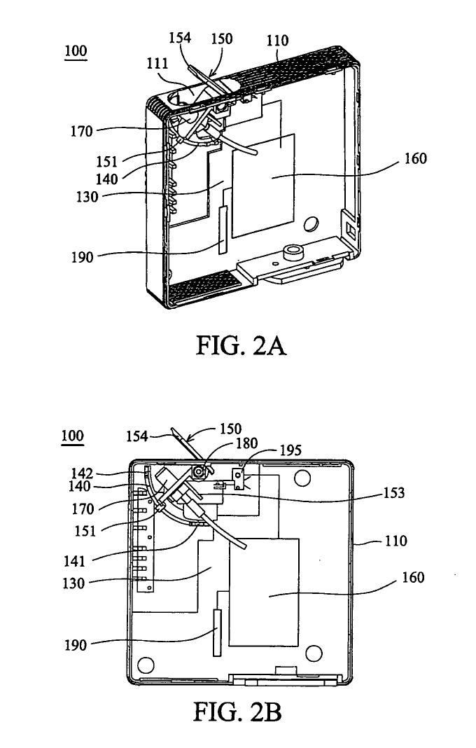

Referring to FIG. 2A and FIG. 2B, the wireless transmission apparatus 100 further comprises a base plate 130, a curved guide track 140, an antenna holder 150, a main circuit board 160, an enhanced antenna 170, a pivot 180, an internal antenna 190, and a switching device 195.

The base plate 130 is disposed in the casing 110 comprising an opening 111. The curved guide track 140 is disposed on the base plate 130 and adjacent to the opening 111 of the casing 110. Additionally, the curved guide track 140 comprises a first engaging portion 141 and a second engaging portion 142, respectively disposed on opposite ends thereof.

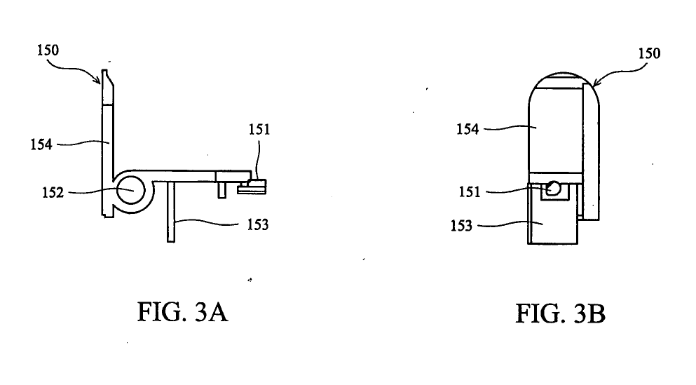

The pivot 180 is disposed on the base plate 130 and adjacent to the opening 111 of the casing 110. The antenna holder 150 pivots on the pivot 180. Specifically, as shown in FIG. 3A and FIG. 3B, the antenna holder 150 further comprises a sliding portion 151, a pivot hole 152, an abutting portion 153, and a barricade 154. The abutting portion 153 is between the pivot hole 152 and the sliding portion 151. The barricade 154 is connected to the pivot hole 152.

As shown in FIG. 2A and FIG. 2B, the antenna holder 150 is rotatably disposed on the base plate 130 by pivoting on the pivot 180. Namely, the pivot 180 is disposed in the pivot hole 152 of the antenna holder 150, such that the antenna holder 150 can rotate around the pivot 180. Specifically, as shown in FIG. 2B and FIG. 3A, the distance between the pivot hole 152 and the sliding portion 151 of the antenna holder 150 substantially equals that from the pivot 180 to the curved guide track 140. Thus, when the antenna holder 150 rotates around the pivot 180, the sliding portion 151 thereof can simultaneously slide on the curved guide track 140 and the antenna holder 150 can rotate between a first position and a second position. Specifically, the sliding portion 151 of the antenna holder 150 engages the first engaging portion 141 of the curved guide track 140 when the antenna holder 150 rotates to the first position. The sliding portion 151 of the antenna holder 150 engages the second engaging portion 142 of the curved guide track 140 when the antenna holder 150 rotates to the second position. Moreover, the sliding portion 151 of the antenna holder 150 can be a protrusion and the first engaging portion 141 and second engaging portion 142 of the curved guide track 140 can be recesses.

As shown in FIG. 2A and FIG. 2B, the main circuit board 160 is disposed on the base plate 130. The enhanced antenna 170, internal antenna 190, and switching device 195 are electrically connected to the main circuit board 160, respectively. Specifically, the enhanced antenna 170 is disposed in the antenna holder 150. When the antenna holder 150 rotates, the enhanced antenna 170 rotates therewith.

Both the enhanced antenna 170 and internal antenna 190 are used to transmit and receive wireless signals. The switching device 195 allows the wireless transmission apparatus 100 to selectively operate the enhanced antenna 170 or internal antenna 190 according to transmission requirements. Moreover, in an embodiment, the enhanced antenna 170 can be an SMA antenna, the internal antenna 190 can be a conventional RF antenna, and the switching device 195 can be a limit switch.

The following description is directed to selective operation of the enhanced antenna 170 or internal antenna 190 in the wireless transmission apparatus 100, according to transmission requirements.

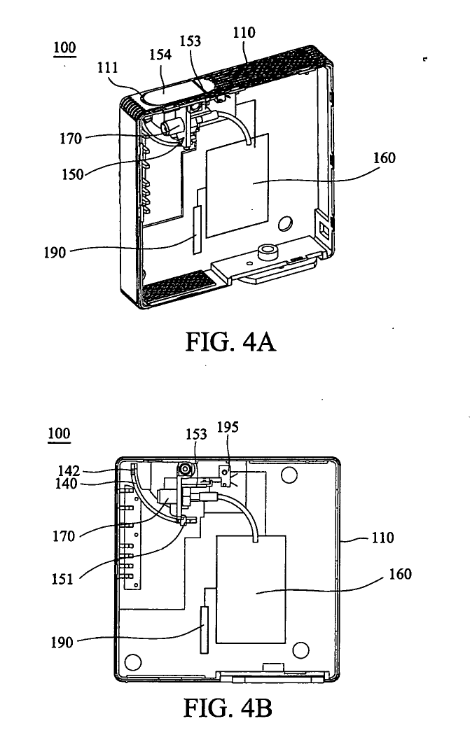

As shown in FIGS. 1, 4A, and 4B, when the antenna holder 150 rotates to the first position around the pivot 180, the enhanced antenna 170 is received or positioned in the casing 110 and the barricade 154 of the antenna holder 150 covers the opening 111 of the casing 110. Moreover, the abutting portion 153 of the antenna holder 150 abuts the switching device 195. At this point, the switching device 195 outputs a switching signal to the main circuit board 160. The main circuit board 160 then allows only the internal antenna 190 to operate, according to the switching signal. Namely, the wireless transmission apparatus 100 enables wireless signal transmission only by way of the internal antenna 190 thereof when the antenna holder 150 therein rotates to the first position.

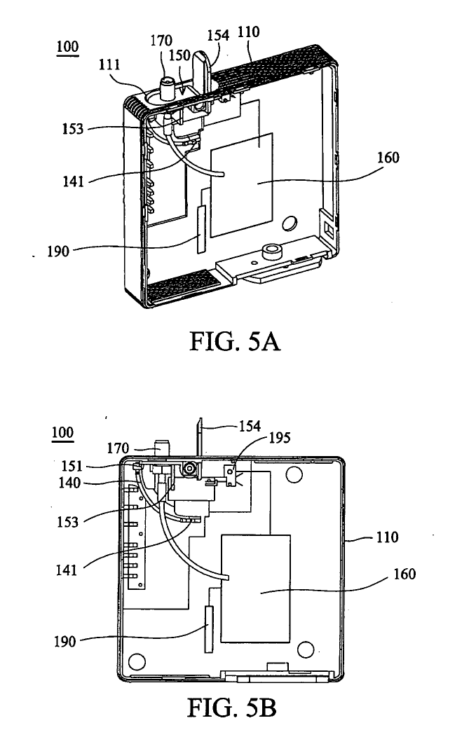

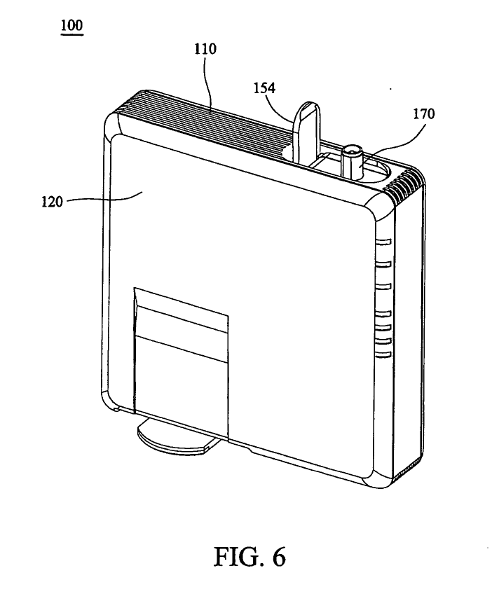

As shown in FIGS. 5A, 5B, and 6, when the antenna holder 150, on the other hand, rotates to the second position around the pivot 180, the enhanced antenna 170 protrudes from the opening 111 of the casing 110 (or extends out of the opening 111) and the abutting portion 153 of the antenna holder 150 is separated from the switching device 195. At this point, the main circuit board 160 allows only the enhanced antenna 170 to perform wireless signal transmission. Namely, the wireless transmission apparatus 100 enables wireless signal transmission only by way of the enhanced antenna 170 thereof when the antenna holder 150 therein rotates to the second position.

In conclusion, since the wireless transmission apparatus 100 is provided with an antenna rotation mechanism as described accordingly, the enhanced antenna 170 can rotate to be received in the wireless transmission apparatus 100 or to the exterior thereof, based upon transmission requirements. Moreover, because of the specific structural design of the antenna holder 150 and curved guide track 140, rotation of the enhanced antenna 170 (or antenna holder 150) is smooth and positioning thereof is precise.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wireless transmission apparatus, comprising:
a base plate;
a curved guide track disposed on the base plate;
an antenna holder rotatably disposed on the base plate and comprising a sliding portion, wherein the sliding portion slides on the curved guide track when the antenna holder rotates;
a main circuit board disposed on the base plate; and
an enhanced antenna disposed in the antenna holder and electrically connected to the main circuit board, wherein the enhanced antenna rotates with the antenna holder.

2. The wireless transmission apparatus as claimed in claim 1, further comprising a pivot disposed on the base plate, wherein the antenna holder pivots on the pivot and rotates between a first position and a second position.

3. The wireless transmission apparatus as claimed in claim 2, wherein the antenna holder further comprises a pivot hole in which the pivot is disposed.

4. The wireless transmission apparatus as claimed in claim 3, wherein the distance between the pivot hole and the sliding portion substantially equals that from the pivot to the curved guide track.

5. The wireless transmission apparatus as claimed in claim 2, wherein the curved guide track further comprises a first engaging portion and a second engaging portion, respectively disposed on opposite ends thereof, the sliding portion of the antenna holder engages the first engaging portion when the antenna holder rotates to the first position, and the sliding portion of the antenna holder engages the second engaging portion when the antenna holder rotates to the second position.

6. The wireless transmission apparatus as claimed in claim 5, wherein the sliding portion comprises a protrusion and the first and second engaging portions comprise recesses.

7. The wireless transmission apparatus as claimed in claim 2, further comprising at least one internal antenna and a switching device, both electrically connected to the main circuit board, wherein the wireless transmission apparatus selectively operates the enhanced antenna or internal antenna by means of the switching device.

8. The wireless transmission apparatus as claimed in claim 7, wherein the antenna holder further comprises an abutting portion between the pivot hole and the sliding portion, the abutting portion abuts the switching device to allow the wireless transmission apparatus to selectively operate the internal antenna when the antenna holder rotates to the first position, and the abutting portion is separated from the switching device to allow the wireless transmission apparatus to selectively operate the enhanced antenna when the antenna holder rotates to the second position.

9. The wireless transmission apparatus as claimed in claim 3, further comprising a casing in which the base plate is disposed, wherein the enhanced antenna is received in the casing when the antenna holder rotates to the first position, and the enhanced antenna protrudes from the casing when the antenna holder rotates to the second position.

10. The wireless transmission apparatus as claimed in claim 9, wherein the casing further comprises an opening adjacent to the pivot and curved guide track, the antenna holder further comprises a barricade connected to the pivot hole thereof, the barricade covers the opening when the antenna holder rotates to the first position, and the enhanced antenna protrudes from the opening when the antenna holder rotates to the second position.

11. The wireless transmission apparatus as claimed in claim 1, wherein the wireless transmission apparatus comprises a router.

12. The wireless transmission apparatus as claimed in claim 1, wherein the enhanced antenna comprises an SMA antenna.

13. The wireless transmission apparatus as claimed in claim 7, wherein the internal antenna comprises an RF antenna.

14. The wireless transmission apparatus as claimed in claim 7, wherein the switching device comprises a limit switch.

15. An antenna rotation mechanism, comprising:
a base plate;
a curved guide track disposed on the base plate;
an antenna holder rotatably disposed on the base plate and comprising a sliding portion, wherein the sliding portion slides on the curved guide track when the antenna holder rotates; and
an antenna disposed in the antenna holder and rotating therewith.

16. The antenna rotation mechanism as claimed in claim 15, further comprising a pivot disposed on the base plate, wherein the antenna holder pivots on the pivot and rotates between a first position and a second position.

17. The antenna rotation mechanism as claimed in claim 16, wherein the antenna holder further comprises a pivot hole in which the pivot is disposed.

18. The antenna rotation mechanism as claimed in claim 16, wherein the distance between the pivot hole and the sliding portion substantially equals that from the pivot to the curved guide track.

19. The antenna rotation mechanism as claimed in claim 16, wherein the curved guide track further comprises a first engaging portion and a second engaging portion, respectively disposed on opposite ends thereof, the sliding portion of the antenna holder engages the first engaging portion when the antenna holder rotates to the first position, and the sliding portion of the antenna holder engages the second engaging portion when the antenna holder rotates to the second position.

20. The antenna rotation mechanism as claimed in claim 19, wherein the sliding portion comprises a protrusion and the first and second engaging portions comprise recesses.
